(19) United States
(12) Patent Application Publication
(10) Pub. No.: US 2014/0032650 A1
(43) Pub. Date: Jan. 30, 2014

(54) SYSTEM AND METHOD FOR PROVIDING NETWORK MANAGEMENT IN USER DEVICES

(71) Applicant: NOVATIUM SOLUTIONS PVT. LTD., Chennai (IN)

(72) Inventors: Alok SINGH, CHENNAI (IN); Gopinath Vinod KUMAR, CHENNAI (IN); Ragunathan RAMAUNGAN, OOTY (IN)

(21) Appl. No.: 13/952,274

(22) Filed: Jul. 26, 2013

(30) Foreign Application Priority Data
Jul. 27, 2012 (IN) 3182/CHE/2012

(51) Int. Cl. H04L 12/24

(52) U.S. Cl. CPC H04L 41/00
USPC 709/203; 709/225; 709/219

(57) ABSTRACT

In one embodiment, a mechanism that enables a service provider to have management control of a user device connected to the service provider's network is provided. This control empowers the service provider to address the issues faced by one or more end users, by providing multiple packages that have fine-grained control on the end user's network needs. Thus each user can have access to their desired applications and websites at the rates and speed of their choice.

### CROSS-REFERENCE TO RELATED APPLICATIONS

This application claims priority to Indian Application Serial No. 3182/CHE/2012 filed Jul. 27, 2012, the contents of which are hereby incorporated by reference.

### FIELD OF INVENTION

The invention generally relates to network management mechanisms and more particularly to systems and methods for providing network management by monitoring network characteristics.

### BACKGROUND OF THE INVENTION

Many of our daily activities are dependent on the functioning and the management of one or more user devices that are computing and/or communication devices. Multitude of these user devices may have varied physical characteristics, attributes and operational characteristics that add complexity to one or more stakeholders including an end user and a service provider. For the end user, it introduces complexity of using different types of user devices and for the service provider it brings in the complexity of maintaining similar user experience and Service Level Agreement (SLAs) on the different types of user devices. Further, since the user devices are connected to the network throughout the day, there is bandwidth consumption in an uninterrupted manner.

Most of the service providers have varied network packages thereby providing an option for the end user to choose the network package based on the user's requirement. The network packages indicate a varied amount of download and upload that a user can perform on that network connection.

Network management is managing fault and performance of a computing environment across applications, servers and networks. Network management tools provide a variety of information to network operators and engineers through monitoring and measuring a variety of performance metrics. However, one limitation associated with the network management systems is their inability to do fine-grained tracking of the end user's network usage. This may lead to the end user overshooting the limit on the amount of data that can be downloaded or uploaded.

As a result, the end user may be unable to gain access to network for the rest of the billing period or the user may use the Internet at an increased pricing slab. In either of the situations, the business relationship between the end user and the service provider gets affected.

An alternative that exists against limited amount of data usage is unlimited data usage at a specified network speed. However in most cases, the data usage that occurs in this space is media centric or concerning a specific media website. These data exchanges consume huge network bandwidth and result in an unsatisfactory network experience for the other users. Hence many a times the service provider is unable to live up to the service level promises made.

Most service providers track the amount of data that is downloaded and control the speed of the network based on the amount of data that is downloaded. When it exceeds a certain threshold then the speed is reduced. This still does not ensure that an average user has a guaranteed experience as control of the bandwidth lies with someone else and the user would thus end up with a poor experience. In some cases, selected downloads are not allowed, like a torrent file or download of big files. It is not generic enough to cut down all downloads that could affect the experience of other users. A few providers also have the ability to do deep packet inspections of the data exchanged over the network. But this is an expensive procedure and is only used selectively. Moreover, all these mechanisms are punitive in nature and only work as a denial of service. There are no mechanisms that guarantee the requisite services to users.

Hence, there exists a need for a mechanism that can be employed by service providers to facilitate efficient network management of a user device connected to their respective network.

### BRIEF DESCRIPTION OF THE INVENTION

The above-mentioned shortcomings, disadvantages and problems are addressed herein which will be understood by reading and understanding the following specification.

In one embodiment, a mechanism that enables a service provider to have management control of a user device connected to the service provider's network is provided. This control empowers the service provider to address the issues faced by one or more end users, by providing multiple packages that have fine-grained control on the end user's network needs. Thus each user can have access to their desired applications and websites at the rates and speed of their choice.

Accordingly, in one embodiment, system and method for providing network management in multiple user devices is provided. The system comprises a plurality of client modules, each client module being installed in a respective user device, the user device being used by a user and at least one server unit interconnecting the client modules, the server unit being configured to control user access to a network via the user device based on a user profile of the user.

The method of providing network management comprises receiving a user request for authentication, the user request comprising one or more user attributes, generating a user profile based on the user attributes, sending the user profile to the client module associated with the user device and managing user access to a network via the user device based on the user profile of the user.

In another embodiment, a method of providing network management is provided. The method comprises receiving a request for user access for a network from a user device, determining eligibility of a user of the user device based on a user profile and managing user access for the network based on eligibility determination.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a block diagram of a system for providing network management in multiple user devices, as described in an embodiment;

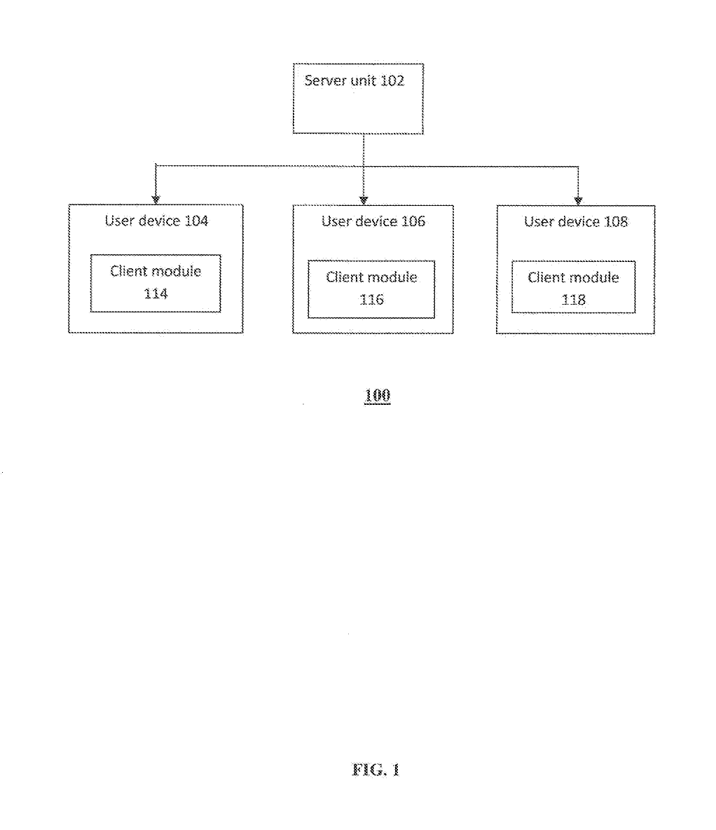

FIG. 2 shows a flow diagram depicting a method of providing network management in multiple user devices, as described in an embodiment; and

FIG. 3 shows a flow diagram depicting a method of providing network management in multiple user devices, as described in another embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The invention describes a mechanism that works on a client-server model wherein a client module is installed on each of the user devices when an end user of the user device subscribes to the services provided by the service provider.

This is done through an authentication and profile exchange mechanism. In one embodiment, the authentication by the service provider determines what type of package is selected by the user device and consequently, an appropriate user profile is sent to the user device. The user profile can also be sent when the package composition is changed by the service provider. Therefore, the user profile may be remotely configured and sent to each of the user devices dynamically.

In another embodiment, a user profile is generated based on one or more user attributes and subsequently one or more subscription packages are offered for selection by the user. Further, upon receiving the user selection, network management of the corresponding user device is performed based on a selected subscription package.

In yet another embodiment, a user profile is generated based on a combination of one or more user attributes and one or more packages subscribed to by the user.

Accordingly, in one embodiment, the invention provides a system and method for providing network management in user devices. The system comprises at least one server unit, and multiple user devices coupled to the server unit, each of the user devices being configured to be able to interact with the server unit, via a client module installed in the user device, to enable the server unit to provide management control of the user device, such that the service provider can provide the desired experience to the end user.

The server unit is configured to control user access to the network based on a user profile of the user. As mentioned in the above embodiments, the user profile may be generated based on the subscription packages selected by the user and/or based on one or more user attributes.

The user profile is generated based on one or more attributes associated with the user. The user device desiring access to the network sends a user request for authentication to the server unit. The user request comprises one or more user attributes.

The server unit is configured to authenticate the user of the user device and based on these user attributes, the server unit generates a user profile and sends the user profile to the client module installed in the user device. Network access to the user device is further controlled based on the user profile. The client module is configured to map these attributes to a network access rule that contains these limitations and thereby regulates network access by each of the associated user devices.

According to one embodiment of the present invention, each user profile can have a predefined set of attributes. In some cases, the retrieved profile may not provide values for each of these attributes. Therefore, the server unit can determine if the received user profile is complete, and, if it is not complete, can fill in the missing attribute values with default values, which can be part of the server unit's local configuration or may be retrieved from the client module by the server unit during, for example, its initialization or startup phase.

The server unit is configured to offer one or more subscription packages to the user based on the user profile. The user can make a selection for one of the subscription packages and communicate the same to the server unit. Based on the selection of the subscription package, the server unit generates a customizable list of applications and websites based on a selected subscription package and sends the same as user profile to the client module installed in the user device associated with the user.

Further, at least two of the user devices in the network may share the network with each other using a tethering mechanism. The tethering mechanism leads to an increased network traffic, which the service provider would like to control. The server unit is further configured to enable or disable tethering on the user's devices depending on the package that the user has chosen through the profile.

In one embodiment, the user device is configured to send a periodic authentication and “I am alive” messages to the respective server unit. The server unit upon receiving the message checks for changes in the profile and if there are modifications, sends them to the client module. These changes occur either due to user subscribing to a new package through a user shop portal or such similar mechanisms or when the service provider changes the attributes of a package already subscribed by the user. The client module on the user device starts executing the modified profile and thereafter user access to the network via the user device is controlled based on the modified user profile of the user.

Upon recording modification in the user profile (possibly based on the user's usage), the server unit is configured to offer one or more subscription packages to the user based on the modified user attributes. The user can make a re-selection for one of the subscription packages through the user shop portal or such similar mechanisms and communicate the same to the server unit. Based on the re-selection of the subscription package, the server unit generates a renewed customizable list of applications and websites based on the re-selected subscription package and sends the same to the client module installed in the user device associated with the user.

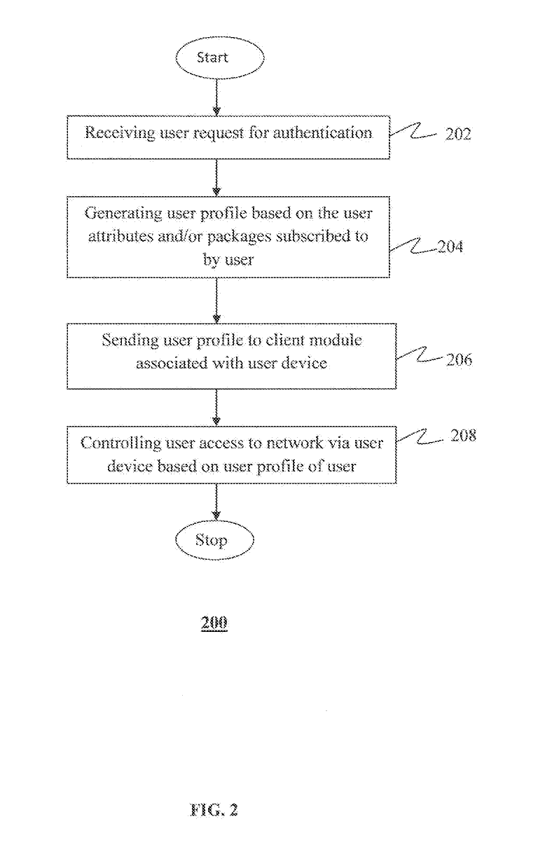

In another embodiment as shown in FIG. 2, a method 200 of providing network management is provided. The method comprises receiving a user request for authentication at step 202, the user request comprising one or more user attributes, generating a user profile based on the user attributes and/or packages subscribed to at step 204, sending the user profile to the client module associated with the user device at step 206 and controlling user access to a network via the user device based on the user profile of the user at step 208.

The method further comprises steps of offering one or more subscription packages to the user based on the user profile, receiving a selection for one of the subscription packages through the user portal or such similar mechanism, generating a customizable list of applications and websites based on a selected subscription package and sending the customizable list to the client module installed in the user device associated with the user.

In one embodiment, the method further comprises receiving a modified user request for authentication, the modified user request comprising one or more modified user attributes, generating a modified user profile based on the modified user attributes, sending the modified user profile to the client module associated with the user device and controlling user access to a network via the user device based on the modified user profile of the user.

The method further comprises offering one or more subscription packages to the user based on the modified user profile, receiving a selection for one of the subscription packages and generating a customizable list of applications and websites based on a selected subscription package; and sending the customizable list to the client module installed in the user device associated with the user.

In another embodiment, the user profile may be generated based on a subscription package selected by the user via a user portal. Accordingly, the server is configured to generate the user profile based on the selected subscription package.

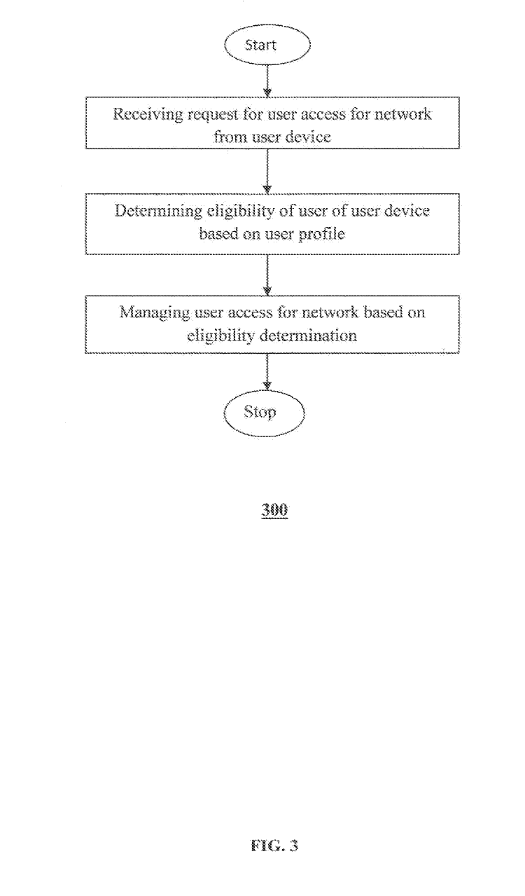

In another embodiment, as shown in FIG. 3, a method 300 of providing network management is provided. The method 300 comprises receiving a request for user access for a network from a user device at step 302, determining eligibility of a user of the user device based on a user profile at step 304 and managing user access for the network based on eligibility determination at step 306.

The method further comprises providing user access for the network upon confirming the eligibility of the user. Alternatively, the method comprises denying user access for the network upon confirming ineligibility of the user.

The method of determining the eligibility comprises receiving a user request for authentication, the user request comprising one or more user attributes, generating a user profile based on one or more subscription packages subscribed to by the user and/or the one or more user attributes, offering one or more subscription packages to the user based on the user profile, receiving a selection for one of the subscription packages, generating a customizable list of applications and websites based on a selected subscription package and sending the customizable list to the client module installed in the user device associated with the user.

Depending on the user profile, the client module on the user device manages the user's consumption of the bandwidth and access to the network. To manage the network access, the client module on the user device is configured to monitor the applications and websites that are being accessed by the user and based on the user profile, the access to the network is controlled.

In a scenario where the eligibility of the user is not confirmed, the client module on the user device, based on the profile sent from the server unit, may send a warning to the user to limit the particular operation or terminate user access to the network or issue warning to the user to cease further attempts to access the network for such operations.

In an exemplary embodiment, if the customized list of application does not include an e-mail application and when a request is made by the user to invoke the email application, then the client module detects that the user does not have right to access the mentioned application and would terminate the invocation of this application post informing the user with an appropriate message.

The method further comprises receiving a modified user request for authentication, the modified user request comprising one or more modified user attributes and/or subscription packages, generating a modified user profile based on the modified user attributes and/or subscription packages, sending the modified user profile to the client module associated with the user device and managing user access to the network via the user device based on the modified user profile of the user.

The method further comprises offering one or more subscription packages to the user based on the modified user profile, receiving a selection for one of the subscription packages, generating a customizable list of applications and websites based on a selected subscription package; and sending the customizable list to the client module installed in the user device associated with the user.

It should be noted that a user can be a human user, a programmatic user, or other user. User device can comprise a desktop, a laptop, a PDA, a cell phone, a smart phone, a desktop computer or any other computing device capable of network communications. Network can be any networks known in the art including, but not limited to, LANs, WANs, the Internet, global communications networks, GSM, CDMA, wireless networks and/or any other communications networks known in the art. Further, it can be selectively turned on for a selected set of network types while letting the other networks have a complete access to the cloud.

Further, the server unit, can also provide any arbitrary services known in the art, including, but not limited to, web server functions, DHCP client for negotiation with ISPs, DHCP server to assign IP addresses to user devices, kernel based packet filtering and stateful inspection, IP sharing, NATplus, port redirection, information and attack logging, automatic updating, VPN masquerade, remote support and configuration, name server configuration and/or web content filtering. User profiles can be used by the server unit to govern provisioning of network access on a user specific basis. By way of example, but not limitation, a user profile can contain attributes to specify upload and download bandwidth allocations for a user, firewall settings, whether the user can use transient VPNs, whether the user can use a selected application, website or service, whether the user can use streaming services or voice over IP services, whether the user should be permitted to perform video teleconferencing, whether the control device should perform virus scanning or worm detection for the user, whether the user can utilize print services, surcharges for services or other settings.

Accordingly, in one embodiment, one or more applications that can be accessed by one or more end users using the user device can be controlled by the client module. The client module thereby denies access to network for a user device or application that subscribes to a package that does not allow the user device to stream and/or download contents from a selected network destination. Further, one or more network sites or destinations can be added in a black list that is maintained in the client module.

In an alternative embodiment, the user may be provided with an option to select a predetermined number of applications and/or websites and to enable or have restrictions on the user device to stream and/or download contents from the selected applications and/or websites. Therefore, even when the end user subscribes to an unlimited data usage packet from the service provider, though the user is provided with unlimited access to selected applications such as news, mail and social networking applications, the control to allow access ultimately lies with the service provider. The service provider therefore may allow the end user to access one or more white listed applications or website while denying access to black listed applications and websites. The white listed applications are the applications that client module provides ready access to.

In another embodiment, a single network connection can be shared by multiple user devices (called tethering) and this increases the bandwidth usage from the end users. For this purpose the client module on the user device is configured through the user profile sent from the server unit to monitor each invocation of the connection to the network through the tethering application and is capable of aborting the invocation upon intimating the end user who initiates invocation.

In yet another embodiment, the client module is configured to monitor network usage by an application and/or website and determine when there is streaming of data from the network. The application can then be terminated based on the information obtained from monitoring subsequent to informing the user.

This tracking can be done on a periodic basis. Accordingly, the client module is configured to track downloads and uploads that occur from the associated user device and subsequently, map this data at an application level. Further, in this case, there is a sizable upload of data from the user device along with the download (for example, the upload to download ratio is seen in the range of about 1:5 to about 1:4).

In contrast, when there is streaming of data, the activity is continuous for a finite period of time depending on the amount of data that is being streamed. In this case, the amount of data uploaded is low as compared to the amount of data that is downloaded (for example, the upload to download ratio is seen in the range of about 1:8 to about 1:12).

In yet another embodiment, the client module is configured to exercise network access control. A predetermined threshold can be placed on the amount of data that can be accessed by the user device from the network. For example, some users can only access 2 KB of data from the network in a specified period of time. This limits the access to the websites and/or applications and enables the end user to access selected type of websites and/or applications depending on the predetermined threshold.

In one embodiment, the method for providing network management in user devices describes a web based administration and self care portal that can be used by an administrator to make changes to the profiles of the user devices.

All the above mentioned controls are used to create specific packages for users. For example, mail package, social network package, and the like. The end user is provided with unlimited access to the network provided by the service provider within the limits specified for each of the packages.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed in the following claims.

What is claimed is:

1. A system for providing network management, the system comprising:
a plurality of client modules, each client module being installed in a respective user device, the user device being used by a user; and
at least one server unit interconnecting the client modules, the server unit being configured to control through the client module the user access to a network via the user device based on a user profile of the user.

2. The system of claim 1, wherein the user profile is generated based on one or more attributes associated with the user.

3. The system of claim 1, wherein the user profile is generated based on one or more subscription packages subscribed to by the user.

4. The system of claim 1, wherein the user profile is generated based on a combination of one or more attributes associated with the user and one or more subscription packages subscribed to by the user.

5. A method of providing network management, the method comprising:
receiving a user request for authentication, the user request comprising one or more user attributes;
generating a user profile based on at least one of one or more attributes associated with the user and one or more subscription packages subscribed to by the user;
sending the user profile to the client module associated with the user device; and
controlling user access to a network via the user device based on the user profile of the user.

6. The method of claim 5, further comprising storing the user profile in the client module.

7. The method of claim 5, further comprising:
offering one or more subscription packages to the user based on the user profile;
receiving a selection for one of the subscription packages;
generating a customizable list of applications and websites based on a selected subscription package; and
sending the customizable list to the client module installed in the user device associated with the user.

8. The method of claim 7, wherein the customizable list of applications includes allowing or disallowing usage of one or more applications configured to share the network with other user devices through a tethering mechanism.

9. The method of claim 5, wherein controlling the user access comprises monitoring network usage by a user to determine when there is streaming of data from the network.

10. The method of claim 5, further comprising:
receiving a modified user request for authentication, the modified user request comprising at least one of one or more modified user attributes and one or more modified subscription packages subscribed to by the user;
generating a modified user profile based on the modified user attributes and the modified subscription packages;
sending the modified user profile to the client module associated with the user device; and
controlling user access to a network via the user device based on the modified user profile of the user.

11. The method of claim 10, further comprising:
offering one or more subscription packages to the user based on the modified user profile;
receiving a selection for one of the subscription packages;
generating a customizable list of applications and websites based on a selected subscription package; and
sending the customizable list to the client module installed in the user device associated with the user.

12. A method of providing network management, the method comprising:
receiving a request for user access for a network from a user device;
determining eligibility of a user of the user device based on a user profile; and
managing user access for the network based on eligibility determination.

13. The method of claim 12, further comprising:
providing user access for the network upon confirming the eligibility of the user.

14. The method of claim 12, further comprising:
denying user access for the network upon confirming ineligibility of the user.

15. The method of claim 12, wherein determining the eligibility comprises:
receiving a user request for authentication, the user request comprising one or more user attributes;
generating a user profile based on the user attributes;
offering one or more subscription packages to the user based on the user profile;
receiving a selection for one of the subscription packages;
generating a customizable list of applications and websites based on a selected subscription package; and
sending the customizable list to the client module installed in the user device associated with the user.

16. The method of claim 12, wherein managing the user access comprises monitoring network usage by a user to determine when there is one of streaming and downloading of data or tethering of the network on the user device and controlling the same based on the user profile sent by the server unit.
